(19) United States
(12) Patent Application Publication
(10) Pub. No.: US 2024/0146083 A1
(43) Pub. Date: May 2, 2024

(54) Power Supply System

(71) Applicant: TOYOTA JIDOSHA KABUSHIKI KAISHA, Toyota-shi (JP)

(72) Inventor: Yoshiaki KIKUCHI, Toyota-shi (JP)

(73) Assignee: TOYOTA JIDOSHA KABUSHIKI KAISHA, Toyota-shi (JP)

(21) Appl. No.: 18/380,681

(22) Filed: Oct. 17, 2023

(30) Foreign Application Priority Data
Nov. 2, 2022 (JP) 2022-176385

(51) Int. Cl. H02J 7/00; H01M 10/0525; H01M 10/46

(52) U.S. Cl. CPC H02J 7/0048; H01M 10/0525; H01M 10/46; H02J 7/0013; H02J 2207/20

(57) ABSTRACT

A power supply system is a power supply system that performs charging and discharging between the power supply system and an external system. The power supply system includes a plurality of battery units and a controller. The plurality of battery units include a plurality of battery packs and a plurality of converters provided corresponding to the plurality of battery assemblies, respectively. The controller controls the plurality of battery units. The plurality of battery units are connected together in parallel. The controller controls a converter of the plurality of converters that corresponds to a battery pack of the plurality of battery packs for which a predetermined period has elapsed since the battery pack is charged to a fully charged state, so as to charge the battery pack to the fully charged state.

This nonprovisional application is based on Japanese Patent Application No. 2022-176385 filed on Nov. 2, 2022 with the Japan Patent Office, the entire contents of which are hereby incorporated by reference.

### BACKGROUND

### Field

The present disclosure relates to a power supply system, and more particularly, to a power supply system in which a plurality of battery units including a plurality of battery assemblies and a plurality of converters are connected in parallel to each other.

### Description of the Background Art

Japanese Patent Application Laid-Open No. 2014-103804 discloses a technique for equalizing voltages of a plurality of battery assemblies in a battery system in which a plurality of battery packs are connected in parallel to each other. Japanese Patent Application Laid-Open No. 2020-60581 discloses a battery having a flat region (voltage flat region) in an OCV (Open Circuit Voltage)-SOC (State Of Charge) characteristic over a wide range.

### SUMMARY

In the case of the battery having a voltage flat region in the OCV-SOC characteristic, it is effective to charge the battery to a fully charged state and to correct an estimated value of the SOC of the battery (calculate the SOC). However, in the power supply system in which the plurality of battery assemblies are connected to the power conversion device in parallel as in Japanese Patent Application Laid-Open No. 2014-103804, all the battery assemblies cannot be charged to the fully charged state due to a difference in internal resistance between the battery assemblies or the like.

It is an object of the present disclosure to provide a power supply system including a plurality of battery assemblies connected together in parallel, so as to allow all the battery assemblies to be charged to a fully charged state and precisely calculate an estimated value of a SOC.

A power supply system of the present disclosure is a power supply system that performs charging and discharging between the power supply system and an external system. The power supply system includes: a plurality of battery units including a plurality of battery assemblies and a plurality of converters provided corresponding to the plurality of battery assemblies, respectively; and a controller that controls the plurality of battery units. The plurality of battery units are connected together in parallel. The controller controls a converter of the plurality of converters that corresponds to a battery assembly of the plurality of battery assemblies for which a predetermined period has elapsed since the battery assembly is charged to a fully charged state, so as to charge the battery assembly to the fully charged state.

According to this configuration, each of the battery units includes the battery assembly and the converter. The plurality of battery units are connected together in parallel. Since each of the battery units includes the battery assembly and the converter, a converter can be used to control charging and discharging of a corresponding battery assembly. By controlling the converter, the corresponding battery assembly can be charged to the fully charged state. The controller controls the converter of the plurality of converters that corresponds to the battery assembly (battery unit) of the plurality of battery assemblies for which the predetermined period has elapsed since the battery assembly is charged to the fully charged state, so as to charge the battery assembly to the fully charged state. Thus, the battery assembly is charged to the fully charged state for each predetermined period. As a result, the estimated value of the SOC of the battery assembly can be corrected (the SOC can be calculated) when fully charged. Therefore, the SOC can be precisely calculated. For example, the controller includes an SOC calculation unit. For each of the plurality of battery assemblies, the SOC calculation unit may set the SOC to a value (100% in one example) corresponding to the fully charged state when the battery assembly is charged to the fully charged state.

The types of the battery assemblies included in the battery unit may not be the same. The plurality of battery assemblies may include, for example, a first battery assembly composed of an iron-phosphate-based lithium ion battery and a second battery assembly composed of a ternary lithium ion battery. In this case, when a first predetermined period has elapsed since the first battery assembly is charged to the fully charged state, the controller may control a converter of the plurality of converters that corresponds to the first battery assembly, so as to charge the first battery assembly to the fully charged state. When a second predetermined period has elapsed since the second battery assembly is charged to the fully charged state, the controller may control a converter of the plurality of converters that corresponds to the second battery assembly, so as to charge the second battery assembly to the fully charged state. Thus, the predetermined period may be changed in accordance with a type of each battery assembly.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing the overall configuration of a power supply system according to the present embodiment.

FIG. 2 is a diagram illustrating an example of an electrically powered vehicle.

FIG. 3 is a diagram showing an example of a configuration of a controller of the power supply system.

FIG. 4 is a flowchart showing an example of a charge control process executed by the controller.

FIG. 5 is a diagram showing the overall configuration of a power supply system according to a modified example.

### DESCRIPTION OF THE EMBODIMENTS

Hereinafter, embodiments of the present disclosure will be described in detail with reference to the accompanying drawings. In the drawings, the same or corresponding parts are denoted by the same reference numerals, and the description thereof will not be repeated.

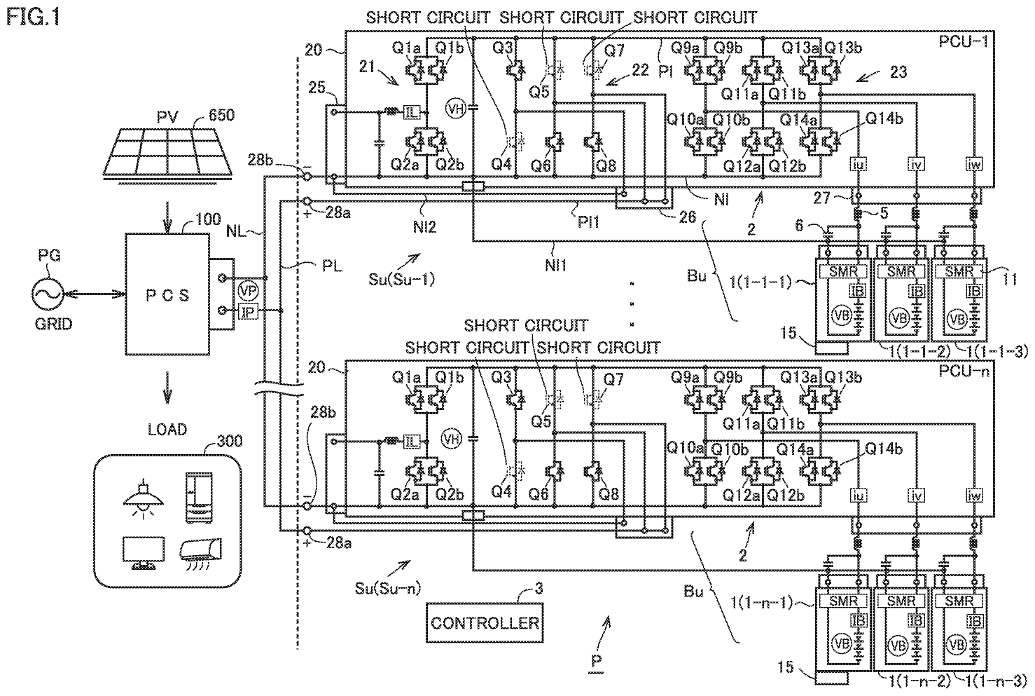

FIG. 1 is a diagram showing the overall configuration of a power supply system according to the present embodiment. Referring to FIG. 1, power supply system P includes a plurality of power supply subunits Su and controller 3. Each of the plurality of power supply subunits Su includes three battery packs 1 and three converters 2. The power supply system P performs charging and discharging with an external system such as a PCS 100 (described later). In the present embodiment, the power supply subunit Su is used for the power supply system P from a battery pack and a power control unit (PCU) mounted on the electrically powered vehicle. Hereinafter, an example of a configuration of an electrically powered vehicle in which a battery pack and a PCU are mounted will be described.

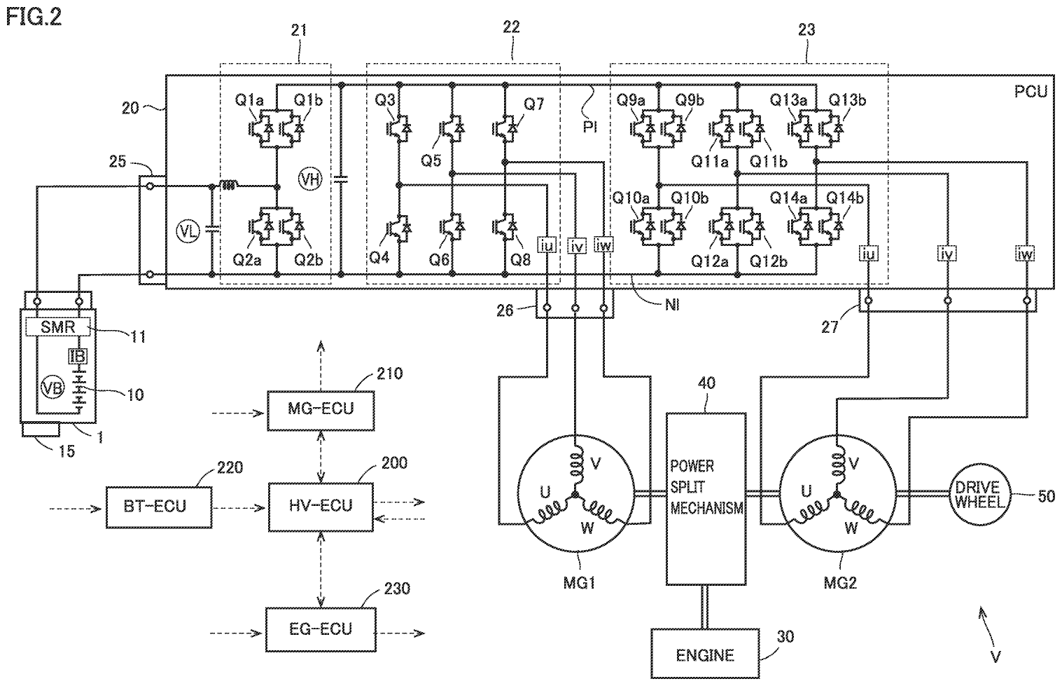

FIG. 2 is a diagram illustrating an example of an electrically powered vehicle. Referring to FIG. 2, electrically powered vehicle V is a hybrid electric vehicle that uses a rotary electric machine and an engine when the vehicle is driven. Electrically powered vehicle V includes battery pack 1, PCU 20, engine 30, motor generators MG1 and MG2, power split mechanism 40, and drive wheels 50.

The battery pack 1 includes a battery 10 and a system main relay (SMR) 11. The battery 10 is a battery assembly including a plurality of single cells (battery cells). The plurality of cells are electrically connected in series. Each cell is composed of a secondary battery such as a nickel-metal hydride battery or a lithium ion battery. The output terminals (positive electrode terminal and negative electrode terminal) of the battery pack 1 are connected to the battery connection terminal 25 of the PCU 20. When the SMR 11 is closed, the battery 10 and the PCU 20 are connected to each other. When the SMR 11 is opened, the connection between the battery 10 and the PCU 20 is interrupted. A monitoring unit 15 is attached to the battery pack 1. The monitoring unit 15 detects the voltage VB of the battery 10, the input/output current IB of the battery 10, and the temperature of the battery 10.

The PCU 20 includes a boost converter 21, an inverter 22, and an inverter 23. The boost converter 21 boosts the battery voltage VB input from the battery pack 1 and outputs the boosted voltage to the inverter 22 and the inverter 23. Inverter 22 converts the DC power boosted from boost converter 21 into three-phase AC power, and drives motor generator MG1, thereby starting engine 30. Inverter 22 converts AC power generated by motor generator MG1 into DC power using power transmitted from engine 30. The DC power is supplied to the boost converter 21. At this time, the boost converter 21 is controlled to operate as a boost circuit. Inverter 23 converts the DC power output from boost converter 21 into three-phase AC power and outputs the three-phase AC power to motor generator MG2.

Power split mechanism 40 is coupled to engine 30 and motor generators MG1 and MG2 to distribute power therebetween. The power split mechanism 40 is, for example, a planetary gear mechanism. In this example, engine 30 is connected to the planetary carrier, motor generator MG1 is connected to the sun gear, and motor generator MG2 is connected to the ring gear. The rotor of motor generator MG2 (and the rotation shaft of the ring gear of power split mechanism 40) is coupled to drive wheel 50 via a reduction gear, a differential gear, and a drive shaft (all not shown). The boost converter 21 of the PCU 20 includes a reactor and switching elements Q1a, Q1b, Q2a, and Q2b. Each of the switching elements Q1a to Q2b is, for example, an IGBT (Insulated Gate Bipolar Transistor) element. A corresponding diode is connected in antiparallel to the IGBT element.

The inverter 22 is a three-phase inverter and includes a U-phase arm, a V-phase arm, and a W-phase arm. Like the switching element Q1a, each of the switching elements Q3 to Q8 includes a diode connected in antiparallel to the IGBT element. The U-phase arm includes switching elements Q3 and Q4. The switching elements Q3 and Q4 are connected in series between the positive electrode line P1 and the negative electrode line N1. The V-phase arm includes switching elements Q5 and Q6. The switching elements Q5 and Q6 are connected in series between the positive electrode line P1 and the negative electrode line N1. The W-phase arm includes switching elements Q7 and Q8. The switching elements Q7 and Q8 are connected in series between the positive electrode line P1 and the negative electrode line N1.

The intermediate point of each phase arm is connected to the corresponding phase coil of motor generator MG1 via MG1 connection terminal 26. Motor generator MG1 is a three-phase permanent magnet synchronous motor, such as an IPM (Interior Permanent Magnet) synchronous motor.

The configuration of the inverter 23 is the same as the configuration of the inverter 22 except that switching elements are provided in parallel in each arm of each phase. The switching elements Q9a and Q9b correspond to the switching element Q3. The switching elements Q10a and Q10b correspond to the switching element Q4. The switching elements Q9a, Q9b, Q10a, and Q10b are included in the U-phase arm of the inverter 23. The switching elements Q11a and Q11b correspond to the switching element Q5. The switching elements Q12a and Q12b correspond to the switching element Q6. The switching elements Q11a, Q11b, Q12a, and Q12b are included in the V-phase arm of the inverter 23. The switching elements Q13a and Q13b correspond to the switching element Q7. The switching elements Q14a and Q14b correspond to the switching element Q8. The switching elements Q13a, Q13b, Q14a, and Q14b are included in the W-phase arm of the inverter 23.

The intermediate point of each phase arm is connected to the corresponding phase coil of motor generator MG2 via MG2 connection terminal 27. Motor generator MG2 is, for example, an IPM synchronous motor.

The electrically powered vehicle V includes, as a controller, a hybrid ECU (Electronic Control Unit), a (HV-ECU) 200, a motor generator ECU (MG-ECU) 210, a battery ECU (BT-ECU) 220, and an engine ECU (EG-ECU) 230. Each ECU includes a CPU (Central Processing Unit), a memory, and a buffer (both not shown).

The monitoring unit 15 includes a voltage detection circuit and a current sensor. The voltage detection circuit detects the voltage (battery voltage) VB of the battery 10 and the cell voltage Vb. The current sensor detects an input/output current IB. The BT-ECU 220 calculates the SOC of the battery 10 based on the voltage VB and the input/output current IB detected by the monitoring unit 15. The BT-ECU 220 transmits the calculated SOC value to the HV-ECU 200.

HV-ECU 200 calculates target engine speed Ne, target engine torque Te, command torque Tm1 of motor generator MG1 and command torque Tm2 of motor generator MG2 for running control of electrically powered vehicle V.

MG-ECU 210 controls each switching element of inverter 22 by PWM (Pulse Width Modulation) so that command torque Tm1 is output from motor generator MG1. MG-ECU 210 controls each switching element of inverter 23 by PWM so that command torque Tm2 is output from motor generator MG2.

The EG-ECU 230 controls the engine 30 so that the engine 30 is operated at the target engine speed Ne and the target engine torque Te.

Referring again to FIG. 1, in the power supply system P, the battery pack 1 and the converter 2 are turned over from the battery pack 1 and the PCU 20 mounted on the electrically powered vehicle V. The positive electrode terminal of the output terminal of the three battery packs 1 (1-1-1, 1-1-2 and 1-1-3) is connected to the MG2 connection terminal 27 via the coil (inductor) 5. Intermediate points of respective phase arms (U-phase arm, V-phase arm, and W-phase arm) of the inverter 23 (three-phase inverter) of the PCU 20 are connected to the MG2 connection terminal 27. The power line between the positive electrode terminal of the battery pack 1 and the coil 5 is connected to the negative electrode terminal of the output terminal of the battery pack 1 via the capacitor 6. The negative electrode terminal of the battery pack 1 is connected to the negative electrode line N1 of the PCU 20 via the power line N11. In FIG. 1, for the sake of convenience, a part of the monitoring unit 15 is not shown.

As shown in FIG. 1, the switching element Q4, the switching element Q5, and the switching element Q7 of the inverter 22 of the PCU 20 are short-circuited. An intermediate point of each phase arm of the inverter 22 is connected to the MG1 connection terminal 26. The MG1 connection terminal 26 includes a terminal connected to the U-phase arm of the inverter 22. This terminal is connected to the negative electrode terminal of the battery connection terminal 25 via the power line N12. The negative electrode terminal of the battery connection terminal 25 is connected to the negative electrode terminal 28b of the power supply subunit Su. The MG1 connection terminal 26 includes terminals connected to the V-phase arm and the W-phase arm. This terminal is connected to the positive electrode terminal 28a of the power supply subunit Su via the power line Pl1.

The battery pack 1 is connected to each phase arm of the inverter 23 of the PCU 20. Some switching elements of the inverter 22 are short-circuited. The MG1 connection terminal 26 is connected to the positive electrode terminal 28a and the negative electrode terminal 28b of the power supply subunit Su. Thus, the PCU 20 is transferred to the converter 2. The converter 2 controls the voltage of the corresponding battery pack 1 (battery 10). The battery pack 1 is connected to an arm of a corresponding phase of the inverter 23.

In FIG. 1, the battery pack 1 or the battery 10 included in the battery pack 1 corresponds to an example of the “battery assembly” of the present disclosure. A chopper circuit composed of a phase arm (connected to one battery pack 1) corresponding to one battery pack 1, a coil 5, and a capacitor 6 corresponds to a “converter” of the present disclosure. In the example of FIG. 1, for the sake of convenience, three converters are collectively denoted by reference numeral 2. The battery pack 1 and a corresponding converter 2 (i.e., a converter 2 connected to the battery pack 1) correspond to the “battery unit” of the present disclosure. For example, in FIG. 1, a battery pack 1-1-1, a U-phase arm (switching elements Q9a, Q9b, Q10a, Q10b), a coil 5 connected to an intermediate point of the U-phase arm, and a capacitor 6 provided on a power line between a positive electrode terminal of the battery pack 1-1 and the coil 5 correspond to a “battery unit” of the present disclosure. In the description of the present embodiment, the reference symbol Bu is used for each battery unit without distinguishing each battery unit.

The power supply subunit Su includes a plurality of (three in this example) battery units Bu. The plurality of battery units each include a plurality of battery packs 1 (batteries 10) and converters 2. In other words, each of the three battery units Bu includes a battery 10 and a converter 2, and each converter 2 is transferred from the PCU 20. In the power supply subunit Su, the three battery units Bu are connected in parallel to each other. The power supply system P includes a plurality of power supply subunits Su. The plurality of power supply subunits Su are connected in parallel to each other with respect to PCS (Power Conditioning System) 100. The PCS 100 is provided outside the power supply system P. In the present embodiment, the plurality of power supply subunits Su are n power supply subunits Su. N is a positive integer, for example, 20. The power supply subunit Su includes three battery units Bu (battery pack 1) connected in parallel to each other. When the power supply system P includes 20 power supply subunits Su, the power supply system P includes 60 battery units Bu (battery pack 1). In FIG. 1, n in the symbol Su-n indicates that the target power supply subunit Su is the n-th power supply subunit Su. N in reference numerals 1-n-1, 1-n-2, and 1-n-3 represents that the target battery pack 1 is included in the n-th power supply subunit Su.

The positive electrode terminal 28a of each power supply subunit Su is connected to the input/output terminal of the PCS 100 via the positive electrode line PL. The negative electrode terminal 28b of each power supply subunit Su is connected to the input/output terminal of the PCS 100 via the negative electrode line NL.

The PCS 100 is connected to a power grid PG, a photovoltaic power generator 650, and a load (electric load) 300 in addition to the power supply system P. The power grid PG includes a power plant and a power transmission network, and is, for example, a commercial power supply. The PCS 100 includes a power converter. The power converter supplies power generated by the photovoltaic power generator 650 to the load 300 and performs reverse flow. The PCS 100 converts AC power of the power grid PG into DC power and charges the battery unit Bu (battery 10) of the power supply system P. The PCS 100 converts discharge power (output power) of the power supply system P (battery unit Bu) into AC power and supplies the AC power to the load 300 or performs reverse flow. The load 300 may be a household electric appliance or may be an electric load of a business or factory.

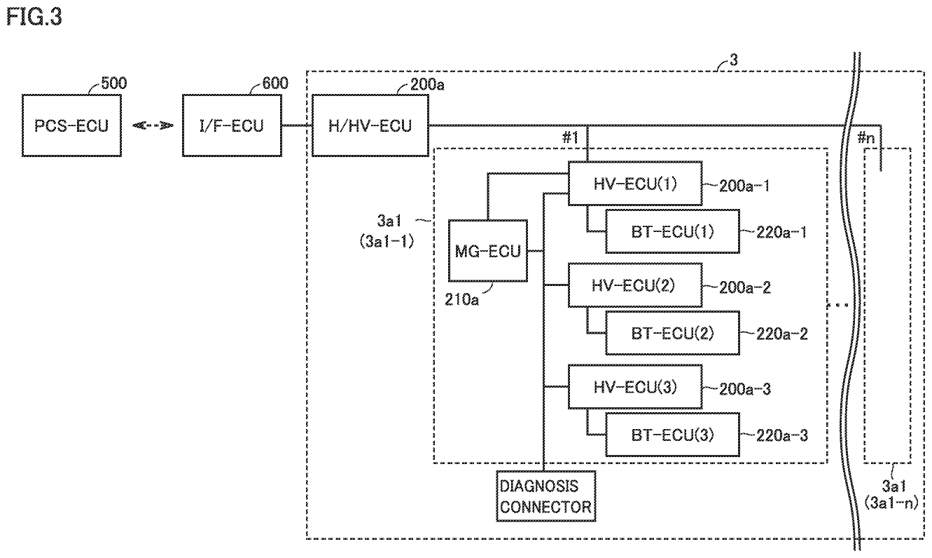

FIG. 3 is a diagram showing an example of the configuration of the controller 3 of the power supply system P. The controller 3 controls a plurality of battery units (more specifically, the converter 2 and the SMR 11 thereof). The controller 3 includes an HV-ECU 200, an MG-ECU 210, and a BT-ECU 220 of the electrically powered vehicle V. Each of the H/HV-ECU 220a and HV-ECU(1)220a-1 to HV-ECU(3)220a-3 includes an HV-ECU 200. The MG-ECU 210a includes an MG-ECU 210. Each of the BT-ECUs 220a1 to 220a-3 includes a BT-ECU 220. Thus, various ECUs of the electrically powered vehicle can be effectively utilized for the power supply system P.

In FIG. 3, a PCS-ECU 500 is a controller that controls the PCS 100. The PCS-ECU 500 outputs a power command RP and a voltage command RV. The power command RP includes a power demand value output from the power supply system P (battery unit Bu) or a power demand value input to the power supply system P. The voltage command RV includes a command value of a voltage output from the power supply system P. An interface ECU (I/F-ECU) 600 interfaces between the PCS-ECU 500 and the controller 3 (H/HV-ECU 200a). The interface ECU 600 matches the communication protocol of the PCS-ECU 500 with the communication protocol of the controller 3. H/HV-ECU 200a receives power command RP and voltage command RV from PCS-ECU 500 via I/F-ECU 600, thereby generating power command RP and voltage command RV for each battery unit Bu. The H/HV-ECU 200a outputs a command for charge control of the battery unit Bu (battery 10).

Sub-controller 3a1 includes MG-ECU 210a, HV-ECU(1)220a-1 to HV-ECU(3)220a-3, and BT-ECUs 220a1 to 220a-3. The sub-controller 3a1 controls the power supply subunit Su.

The sub-controller 3a1 -1 controls the power supply subunit Su-1 (FIG. 1). The sub-controller 3a1 is provided for each power supply subunit Su. That is, the controller 3a includes n sub-controllers 3a1 including sub-controllers 3a1-1 to 3a1-n.

In FIG. 3, the BT-ECU (1) 220a-1 monitors the voltage VB, the input/output current IB, and the temperature of the battery 10 of the battery pack 1-1-1 of the power supply subunit Su-1. The BT-ECU (1) 220a-1 includes an SOC calculation unit. The SOC calculation unit calculates the SOC of the battery 10 (battery assembly) based on the voltage VB, the input/output current IB, and the temperature. HV-ECU (1) 200a-1 controls the open/closed state of SMR 11 of battery pack 1-1-1 based on power command RP and voltage command RV. The HV-ECU 200(1) 200a-1 detects the degree of degradation of the battery 10 of the battery pack 1-1-1. BT-ECU(2) 220a-2 and HV-ECU(2) 200a-2 perform the same processing as BT-ECU(1) 220a-1 and HV-ECU(1) 200a-1 for battery pack 1-1-2. BT-ECU (3) 220a-3 and HV-ECU (3) 200a-3 perform the same processing as BT-ECU (1) 220a-1 and HV-ECU (1) 200a-1 for battery pack 1-1-3. The MG-ECU 210a controls the converter 2 (drives the switching elements of the respective phase arms of the inverter 23) based on the voltage command RV and the power command RP or based on a charge control command from the H/HV-ECU 200a.

The sub-controllers 3a1-2 to 3a1-n perform the same processing as the sub-controller 3a1-1 for the power supply subunits Su-2 to Su-n, respectively.

In the present embodiment, the battery pack 1 (battery 10) is a battery assembly composed of lithium ion batteries. The type of lithium ion battery may be different for each battery pack 1. One kind of lithium ion battery is an iron phosphate lithium ion battery (LFP battery). Hereinafter, of the plurality of battery packs 1 (battery 10), the battery pack 1 (battery 10) composed of LFP batteries is also referred to as a “first battery assembly”. Other types of lithium ion batteries include ternary lithium ion batteries, manganese lithium ion batteries, or NCA lithium ion batteries. Of the plurality of battery packs 1 (battery 10), the battery pack 1 (battery 10) made of these types of lithium ion batteries is also referred to as a “second battery pack”. Thus, the plurality of battery packs 1 (batteries 10) of the battery unit Bu include the first battery assembly and the second battery assembly.

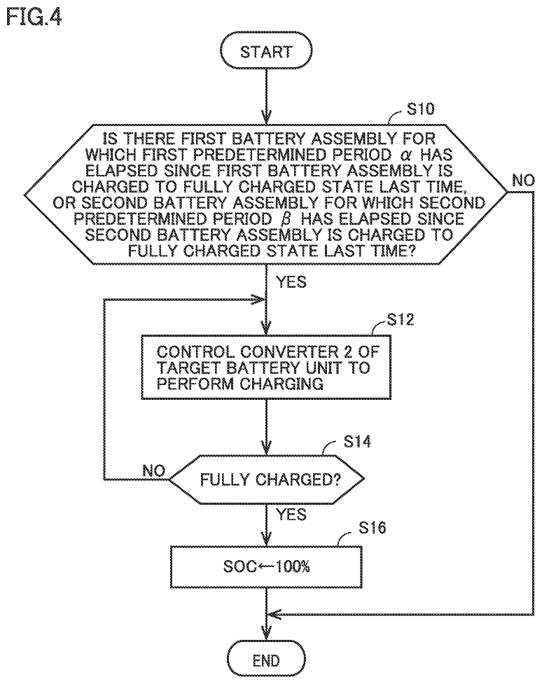

FIG. 4 is a flowchart showing an example of a charge control process executed by the controller 3. This flowchart is repeatedly processed every predetermined time during the operation of the power supply system P. Hereinafter, the step is abbreviated as “S”.

In S10, the H/HV-ECU 200a determines whether or not a first predetermined period α has elapsed after the first battery assembly was charged to the fully charged state the last time for the battery unit Bu including the first battery assembly (the battery pack 1 composed of LFP batteries). Similarly, the H/HV-ECU 200a determines whether or not the second predetermined period β has elapsed after the second battery assembly was charged to the fully charged state the last time for the battery unit Bu including the second battery assembly (for example, the battery pack 1 made of a ternary lithium ion battery) has been charged to the fully charged state the last time. The first predetermined period α is, for example, one week. The second predetermined period β is, for example, 30 days. The process of S10 corresponds to a process of determining whether or not there exists a first battery assembly having a first predetermined period α after the last full charge or a second battery assembly having a second predetermined period β after the last full charge.

When the first predetermined period α has not elapsed since the first battery assembly was charged to the fully charged state the last time and the second predetermined period β has not elapsed since the second battery assembly was charged to the fully charged state the last time (NO in S10), the current routine ends. When the first predetermined period α has elapsed after the first battery pack was charged to the fully charged state the last time, or when the second predetermined period β has elapsed after the second battery assembly was charged to the fully charged state the last time (Yes in S10), the process proceeds to S12. When a positive determination is made in S10, the plurality of battery units Bu include at least one target battery unit Bu (described later).

In S12, the H/HV-ECU 200a controls the converter 2 of the target battery unit Bu to charge the battery pack 1 (battery 10) of the target battery unit Bu. The target battery unit Bu is a battery unit Bu including a first battery assembly having a first predetermined period α after full charge or a second battery assembly having a second predetermined period β after full charge. Specifically, in S12, the H/HV-ECU 200a controls the converter 2 (connected to the first battery pack) corresponding to the first battery assembly out of the plurality of converters 2 so that the first battery assembly is charged to the fully charged state when the first predetermined period α has elapsed since the first battery assembly is charged to the fully charged state. The H/HV-ECU 200a controls the converter 2 (connected to the second battery pack) corresponding to the second battery assembly out of the plurality of converters 2 so as to charge the second battery assembly to the fully charged state when the second predetermined period β has elapsed since the second battery assembly is fully charged. The target battery unit Bu may be charged by power supplied from the power grid PG, or may be charged by power supplied from other battery units Bu.

Subsequently, in S14, the H/HV-ECU 200a determines whether or not the target battery unit Bu (more specifically, the battery 10 thereof) has been charged to the fully charged state. In S12, the H/HV-ECU 200a charges the battery 10 by CV (Content Voltage) charging immediately before the battery 10 of the target battery unit Bu is fully charged. For example, the H/HV-ECU 200a starts charging the battery 10 by charging CCCV (Constant Current, Constant Voltage), and charges the battery 10 with a constant current until the battery 10 reaches a predetermined voltage. After the voltage VB of the battery 10 reaches a specified value, the H/HV-ECU 200a charges the battery 10 with a constant voltage. In S14, the H/HV-ECU 200a determines that the battery 10 has been charged to the fully charged state when the charge current of the battery 10 becomes equal to or less than the set value during the CV charge. The charging method is not limited to CCCV charging, and may be CPCV (Constant Power, Constant Voltage) charging, or may be a method of charging the battery 10 by CV charging from the start of charging.

When the charging current is equal to or less than the set value and it is determined that all the target battery units Bu (more specifically, the battery 10) are fully charged (Yes in S14), the process proceeds to S16. When the full charge of all the target battery units Bu (battery 10) is not completed, that is, when at least one target battery unit Bu (battery 10) is not charged to the full charge state (NO in S14), the process returns to S12. Thereafter, S12 is executed until the full charge of all the target battery units Bu (battery 10) is completed.

In S16, the controller 3 (BT-ECU(1) to (3) 220a-1 to 220a-3) sets the SOC of the target battery unit Bu (battery 10) charged to the fully charged state to 100% (value corresponding to the fully charged state). That is, the H/HV-ECU 200a sets the SOC of the battery 10 to 100% when the battery 10 is charged to the fully charged state for each of the plurality of batteries 10. After S16, the current routine is terminated. The controller 3 estimates (calculates) the SOC of the battery unit Bu (battery 10) charged to the fully charged state by using the current integration method. In addition to the current integration method, the controller 3 may calculate (correct) the SOC using the OCV-SOC characteristic.

According to the present embodiment, the power supply system P includes a plurality of battery units Bu connected in parallel to each other. The battery unit Bu includes a battery pack 1 (battery 10) and a converter 2. Thus, charge and discharge of the battery pack 1 (battery 10) can be controlled using the converter 2. By controlling converter 2, battery 10 can be charged until full charge. The controller 3 controls the converter 2 corresponding to the battery 10 among the plurality of converters 2 so as to charge the battery unit Bu (battery 10) of the plurality of battery units Bu (battery 10) which has elapsed a predetermined period after the battery unit Bu (battery 10) has been charged to the fully charged state the last time until the fully charged state. Thus, the battery unit Bu (battery 10) is charged up to full charge every predetermined period. By setting the SOC to 100% (value corresponding to full charge) during full charge, the estimation accuracy (calculation accuracy) of the SOC can be improved.

In the present embodiment, the first battery assembly is formed of an LFP battery. The first battery assembly is charged to the fully charged state every time a first predetermined period α has elapsed since the first battery assembly is charged to the fully charged state the last time. The second battery assembly is composed of a ternary lithium ion battery. The second battery assembly is charged to the fully charged state every time a second predetermined period β has elapsed since the second battery assembly is charged to the fully charged state the last time. The LFP battery has a wide voltage flat region in the OCV-SOC characteristic. Conventionally, the estimation accuracy (calculation accuracy) of the SOC of the LFP battery is low, and the calculated SOC tends to deviate earlier than the actual value. In the present embodiment, the first predetermined period α is set shorter than the second predetermined period β. This makes it possible to increase the frequency with which the SOC of the LFP battery is corrected. As a result, the SOC can be accurately calculated. In addition, the frequency at which the battery 10 is charged to the fully charged state can be appropriately set for each battery unit Bu.

In the present embodiment, for each of the plurality of converters 2 of the battery unit Bu, the converter 2 is inverted from an inverter 23 (three-phase inverter) included in the PCU 20 of the electrically powered vehicle V. In addition, the battery pack 1 of the battery unit Bu is the battery pack 1 of the electrically powered vehicle V. Therefore, it is possible to promote reuse of the battery and the PCU, which are collected in association with buying, disassembling, and the like of the electrically powered vehicle V. The controller 3 includes an HV-ECU 200, an MG-ECU 210, and a BT-ECU 220 of the electrically powered vehicle V. Therefore, reuse of these ECUs can be promoted.

In the above embodiment, the frequency at which the battery pack 1 (battery 10) is charged to the fully charged state varies depending on the type of lithium ion battery of the battery 10. On the other hand, regardless of the type of lithium ion battery, all battery units Bu may be charged to the fully charged state every time a first predetermined period α has elapsed since the battery units Bu have been charged to the fully charged state the last time.

### Modified Example

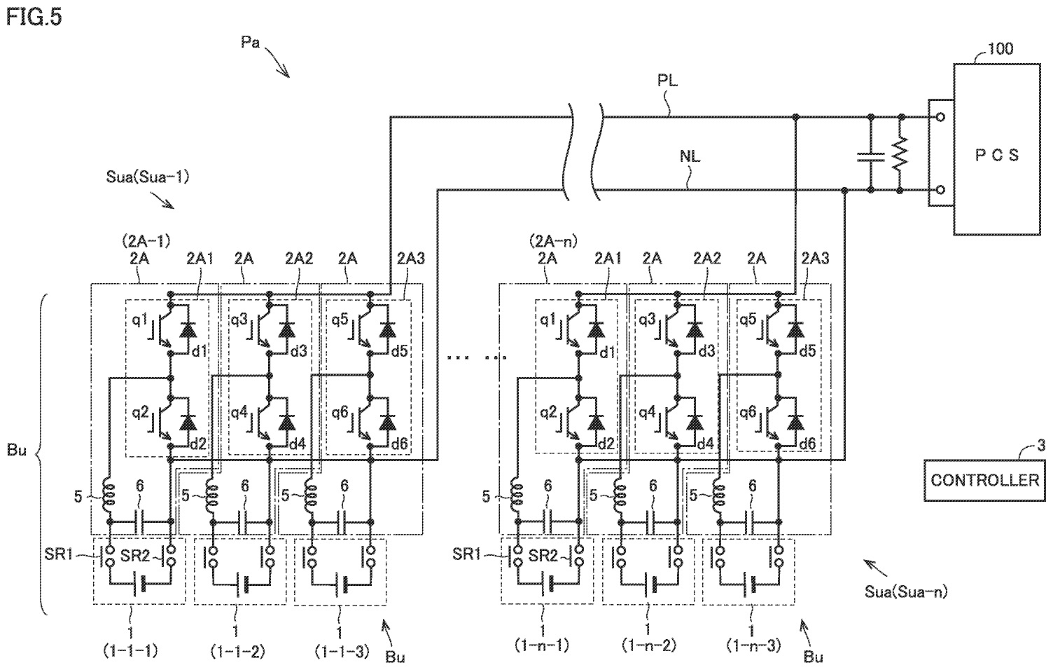

FIG. 5 is a diagram showing the overall configuration of a power supply system Pa according to a modified example. In the above embodiment, the PCU 20 includes the boost converter 21, the inverter 22, and the inverter 23, and is connected to the converter 2 of the power supply system P. In the above-described embodiment, two switching elements of the inverter 23 arranged in parallel to each other are used as switching elements of the converter 2 so that large electric power can pass therethrough. However, a PCU mounted on an electrically powered vehicle may not include an inverter or a boost converter at all.

The converter 2A of the power supply system Pa in the modified example is switched from a PCU including a single inverter or from a circuit in which the inverter portion is extracted from the PCU.

Referring to FIG. 5, for a plurality of converters 2A, converters 2A are switched from inverters (three-phase inverters) of PCUs mounted on electrically powered vehicles. SR1 and SR2 of the battery pack 1 are system main relays (SMR). As in the above embodiment, the positive electrode terminal of the output terminal of the three battery packs 1 (1-1-1, 1-1-2 and 1-1-3) is connected to the middle point of each phase arm (the U-phase arm 2A1, the V-phase arm 2A2, and the W-phase arm 2A3) of the three-phase inverter of the PCU via the coil (inductor) 5. The power line between the positive electrode terminal of the battery pack 1 and the coil 5 is connected to the negative electrode terminal of the output terminal of the battery pack 1 via the capacitor 6. The upper arms of the respective phase arms (the U-phase arm 2A1, the V-phase arm 2A2, and the W-phase arm 2A3) of the three-phase inverter are connected to the positive electrode line PL, and are connected to the input/output terminals of the PCS 100 through the positive electrode line PL. The lower arms of the respective phase arms (the U-phase arm 2A1, the V-phase arm 2A2, and the W-phase arm 2A3) of the three-phase inverter are connected to the negative electrode line NL, and are connected to the input/output terminals of the PCS 100 through the negative electrode line NL. The negative electrode terminal of the battery pack 1 is connected to the negative electrode line NL. The monitoring unit 15 is not shown. In the power supply system Pa according to the modified example, each phase arm of the three-phase inverter of the PCU is connected to the battery pack 1 corresponding to the converter 2A among the plurality of battery packs 1 (battery 10). The three-phase inverter is connected to the converter 2A. The converter 2A is included in a power supply subunit Sua having three battery units Bu.

In the power supply system according to the above-described embodiments and modifications, the three-phase inverter is coupled to the converter. However, the converter included in the battery unit Bu may not necessarily be replaced by a three-phase inverter. The converter may include independent chopper circuits (converters) for each battery unit Bu.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power supply system that performs charging and discharging between the power supply system and an external system, the power supply system comprising:
a plurality of battery units including a plurality of battery assemblies and a plurality of converters provided corresponding to the plurality of battery assemblies, respectively; and
a controller that controls the plurality of battery units, wherein
the plurality of battery units are connected together in parallel, and
the controller controls a converter of the plurality of converters that corresponds to a battery assembly of the plurality of battery assemblies for which a predetermined period has elapsed since the battery assembly is charged to a fully charged state, so as to charge the battery assembly to the fully charged state.

2. The power supply system according to claim 1, wherein
the plurality of battery assemblies includes a first battery assembly composed of an iron-phosphate-based lithium ion battery and a second battery assembly composed of a ternary lithium ion battery,
when a first predetermined period has elapsed since the first battery assembly is charged to the fully charged state, the controller controls a converter of the plurality of converters that corresponds to the first battery assembly, so as to charge the first battery assembly to the fully charged state,
when a second predetermined period has elapsed since the second battery assembly is charged to the fully charged state, the controller controls a converter of the plurality of converters that corresponds to the second battery assembly, so as to charge the second battery assembly to the fully charged state, and
the first predetermined period is set to be shorter than the second predetermined period.

3. The power supply system according to claim 1, wherein
the controller includes an SOC calculation unit that calculates an SOC of the battery assembly, and
for each of the plurality of battery assemblies, the SOC calculation unit sets the SOC to a value corresponding to the fully charged state when the battery assembly is charged to the fully charged state.

4. The power supply system according to claim 3, wherein
for each of the plurality of converters, the converter is diverted from a three-phase inverter, and
a battery assembly of the plurality of battery assemblies that corresponds to the converter is connected to each phase arm of the three-phase inverter.
